(19) United States
(12) Patent Application Publication
(10) Pub. No.: US 2016/0282774 A1
(43) Pub. Date: Sep. 29, 2016

(54) HEATING MEMBER, FIXING DEVICE, AND IMAGE FORMING APPARATUS

(71) Applicant: FUJI XEROX CO., LTD., Tokyo (JP)

(72) Inventors: Yasuhiro UEHARA, Kanagawa (JP); Mitsuhiro MATSUMOTO, Kanagawa (JP); Kazuyoshi ITO, Kanagawa (JP); Mikio SAIKI, Kanagawa (JP)

(73) Assignee: FUJI XEROX CO., LTD., Tokyo (JP)

(21) Appl. No.: 14/829,833

(22) Filed: Aug. 19, 2015

(30) Foreign Application Priority Data
Mar. 24, 2015 (JP) 2015-060245

(51) Int. Cl. G03G 15/20

(52) U.S. Cl. CPC G03G 15/206

(57) ABSTRACT

A heating member includes a flexible surface heater and an auxiliary heating portion. The flexible surface heater has a fixed end side and a free end side, has a contact region in contact with a member to be heated on the free end side and a non-contact region on the fixed end side, is partially fixed, and includes a heating portion in the contact region. The auxiliary heating portion supplementally heats the non-contact region on the fixed end side of the flexible surface heater so as to suppress an occurrence of a temperature difference between the free end side and the fixed end side of the flexible surface heater.

### CROSS-REFERENCE TO RELATED APPLICATIONS

This application is based on and claims priority under 35 USC 119 from Japanese Patent Application No. 2015-060245 filed Mar. 24, 2015.

### BACKGROUND

### Technical Field

The present invention relates to a heating member, a fixing device, and an image forming apparatus.

### SUMMARY

According to an aspect of the present invention, a heating member includes a flexible surface heater and an auxiliary heating portion. The flexible surface heater has a fixed end side and a free end side, has a contact region in contact with a member to be heated on the free end side and a non-contact region on the fixed end side, is partially fixed, and includes a heating portion in the contact region. The auxiliary heating portion supplementally heats the non-contact region on the fixed end side of the flexible surface heater so as to suppress an occurrence of a temperature difference between the free end side and the fixed end side of the flexible surface heater.

### BRIEF DESCRIPTION OF THE DRAWINGS

Exemplary embodiments of the present invention will be described in detail based on the following figures, wherein:

FIG. 1 illustrates an overall structure of an image forming apparatus to which a fixing device according to a first exemplary embodiment of the present invention is applied;

FIG. 2 is a sectional view of the structure of the fixing device according to the first exemplary embodiment of the present invention;

FIG. 3 is a sectional view illustrating the structure of the fixing belt;

FIG. 4 is a perspective view illustrating the structure of a flexible surface heating member;

Fig, 5 illustrates the structure of the flexible surface heating member before the flexible surface heating member is attached and after the flexible surface heating member has been attached;

FIG. 6 is a sectional view illustrating the structure of the flexible surface heating member;

FIG. 7 is a plan view illustrating the structure of a heating portion of the flexible surface heating member;

FIG. 8 is a schematic view illustrating the heating portion of the flexible surface heating member;

FIG. 9 illustrates a configuration of a controller of the fixing device according to the first exemplary embodiment of the present invention;

FIG. 10 is a plan view illustrating the structure of a heating portion of a heating member as a comparative example;

FIG. 11A is a graph illustrating a temperature distribution of the heating member of the comparative example, and FIG. 11B is a graph illustrating a temperature distribution of the heating member according to the first exemplary embodiment of the present invention;

FIG. 12 is a schematic view illustrating deformation of the heating member;

FIG. 13 is a perspective structural view illustrating the deformation of the heating member;

FIGS. 14A and 14B are graphs respectively illustrating results with an experimental example and the comparative example; and

FIG. 15 illustrates the structure of a fixing device according to a second exemplary embodiment of the present invention.

### DETAILED DESCRIPTION

Exemplary embodiments of the present invention will be described below with reference to the drawings.

### First Exemplary Embodiment

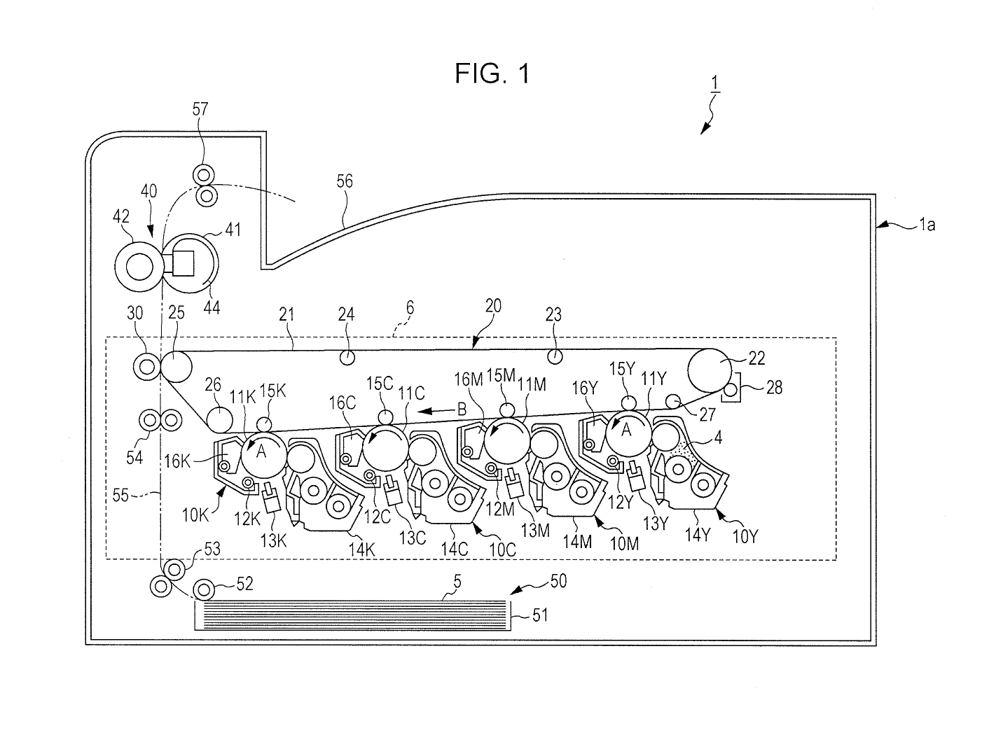

FIG. 1 is a schematic view of an outline of an image forming apparatus to which a fixing device according to a first exemplary embodiment of the present invention is applied.

### The Outline Structure of an Image Forming Apparatus

An image forming apparatus 1 according to the first exemplary embodiment is, for example, a color printer. The image forming apparatus 1 includes components such as plural image forming devices 10, an intermediate transfer device 20, a sheet feed device 50, and a fixing device 40. The image forming devices 10 each form a toner image developed by toner included in developer 4. The intermediate transfer device 20 holds the toner images formed by the image forming devices 10 and transports the toner images to a second transfer position where the toner images are transferred onto recording sheets 5 at last through second transfer. The recording sheets 5 each serve as an example of a recording medium. The sheet feed device 50 contains and transports the required plural recording sheets 5 each to be supplied to the second transfer position of the intermediate transfer device 20. The fixing device 40 according to the present exemplary embodiment fixes the toner images that have been transferred onto the recording sheet 5 by the intermediate transfer device 20 through the second transfer. The plural image forming devices 10 and the intermediate transfer device 20 are included in an image forming section 6 that serves as an example of an image forming unit that forms an image on the recording sheet 5. Reference numeral 1a of FIG. 1 indicates a body of the image forming apparatus 1. This body 1a includes a support structural member, an exterior covering, and so forth.

The image forming devices 10 include four image forming devices 10Y, 10M, 10C, and 10K that each dedicatedly form a toner image of a corresponding one of four colors, that is, yellow (Y), magenta (M), cyan (C), and black (K). These four image forming devices 10 (Y, M, C, and K) are inclined and arranged along a line in an inner space of the body 1a.

As illustrated in FIG. 1, the image forming devices 10 (Y, M, C, and K) include respective photosensitive drums 11 that are rotated. The photosensitive drums 11 each serve as an example of an image holding body. The following devices that each serve as an example of a component for toner image formation are disposed around each of the photosensitive drums 11. That is, the devices around the photosensitive drum 11 include, for example, a charger 12, a light exposure device 13, a corresponding one of developing devices 14 (Y, M, C, and K), a corresponding one of first transfer devices 15 (Y, M, C, and K), and a corresponding one of drum cleaners 16 (Y, M, C, and K). The charger 12 charges a circumferential surface (image holding surface) of the photosensitive drum 11 where image formation is possible to a required potential. The light exposure device 13 radiates light in accordance with information (signal) of an image to the charged circumferential surface of the photosensitive drum 11 so as to form an electrostatic latent image (for a corresponding one of the colors) having a potential difference. The developing device develops the electrostatic latent image into a toner image with the developer 4 for a corresponding one of the colors (Y, M, C, and K). The first transfer device 15 transfers the toner image onto the intermediate transfer device 20. The drum cleaner 16 cleans the image holding surface of the photosensitive drum 11 by removing adhering matter such as toner remaining on and adhering to the image holding surface of the photosensitive drum 11 having undergone first transfer.

Each of the photosensitive drums 11 includes a grounded cylindrical or columnar base member. The image holding surface having a photoconductive layer (photosensitive layer) made of a photosensitive material is formed on the circumferential surface of the base member. The photosensitive drum 11 is supported so as to be rotated in an arrow A direction by motive power transmitted from a rotation drive device (not illustrated).

The charger 12 uses a contact-type charging roller disposed in a state in which the charger 12 is in contact with the photosensitive drum 11. A charging voltage is supplied to the charger 12. In the case where the developing device 14 performs reversal development, a voltage or a current the polarity of which is the same as that of the toner supplied from this developing device 14 is supplied as the charging voltage. The charger 12 may be a contactless-type charging device such as a scorotron disposed on the surface of the photosensitive drum 11 in a state in which the charger 12 is not in contact with the photosensitive drum 11.

The light exposure device 13 forms the electrostatic latent image by radiating the light formed in accordance with image information input to the image forming apparatus 1 to the circumferential surface of the charged photosensitive drum 11. The image information (signal) input to the image forming apparatus 1 by an arbitrary device is transmitted to the light exposure device 13 at a time when the electrostatic latent image is formed.

The light exposure device 13 includes an LED print head that forms the electrostatic latent image by radiating the light in accordance with the image information to the photosensitive drum 11. The LED print head includes plural light emitting diodes (LEDs) that serve as plural light emitting elements arranged along the axial direction of the photosensitive drum 11. Alternatively, the light exposure device 13 may use laser light formed in accordance with the image information and used to perform deflection scanning along the axial direction of the photosensitive drum 11.

The developing devices 14 (Y, M, C, and K) each include a housing, a developing roller, agitation and transport members, a layer thickness regulating member, and so forth. The developing roller, the agitation and transport members, the layer thickness regulating member, and so forth are disposed in the housing that has an opening and a developer chamber. The developing roller holds and transports the developer to a developing region that faces a corresponding one of the photosensitive drums 11. The agitation and transport members include, for example, two screw augers that transport the developer so as to cause the developer to pass through the developing roller while agitating the developer. The layer thickness regulating member regulates the amount (layer thickness) of the developer held by the developing roller. A developing voltage is supplied between the developing roller and the photosensitive drum 11 of the developing device 14 from a power unit (not illustrated). Furthermore, the developing roller and the agitation and transport members are rotated in required directions by motive power transmitted from a rotation drive device (not illustrated). Furthermore, two-component developer that includes non-magnetic toner and magnetic carrier is used as the developer 4 for each of four colors (Y, M, C, and K).

Each of the first transfer devices 15 (Y, M, C, and K) is a contact-type transfer device that includes a first transfer roller that is in contact with a circumference of the photosensitive drum 11 through the intermediate transfer belt 21 so as to be rotated. A first transfer voltage is supplied to the first transfer roller. The first transfer voltage is a direct-current voltage the polarity of which is opposite to the polarity to which the toner is charged. The first transfer voltage is supplied from a power unit (not illustrated).

Each of the drum cleaners 16 includes components such as a body, a cleaning plate, and a feed member. The part of the container-shaped body is open. The cleaning plate is disposed so as to be in contact at a required pressure with the circumferential surface of a corresponding one of the photosensitive drums 11 having undergone the first transfer, thereby cleaning the circumferential surface of the photosensitive drum 11 by removing the adhering matter such as residual toner. A screw auger or the like is used as the feed member that collects and transports the adhering matter such as toner removed by the cleaning plate so that the removed adhering matter is fed to a collection system (not illustrated). A plate-shaped member (for example, a blade) formed of a material such as rubber is used as the cleaning plate.

As illustrated in FIG. 1, the intermediate transfer device 20 is disposed above the image forming devices 10 (Y, M, C, and K). The intermediate transfer device 20 includes components such as an intermediate transfer belt 21, plural belt support rollers 22 to 27, a second transfer device 30, and a belt cleaner 28. The intermediate transfer belt 21 is rotated in an arrow B direction while passing through first transfer positions between the photosensitive drums 11 and the first transfer devices 15 (first transfer rollers). The plural belt support rollers 22 to 27 hold the intermediate transfer belt 21 in a state from inside and support the intermediate transfer belt 21 such that the intermediate transfer belt 21 is rotatable. The second transfer device 30 is disposed on an outer circumferential surface (image holding surface) side of the intermediate transfer belt 21 supported by the belt support roller 25 and causes the toner images on the intermediate transfer belt 21 to be transferred onto the recording sheet 5 through the second transfer. The second transfer device 30 serves as an example of a second transfer member. The belt cleaner 28 cleans the outer circumferential surface of the intermediate transfer belt 21 by removing the adhering matter such as toner and paper dust remaining on and adhering to the outer circumferential surface of the intermediate transfer belt 21 after the intermediate transfer belt 21 has passed through the second transfer device 30.

The intermediate transfer belt 21 is an endless belt formed of a material including, for example, synthetic resin such as polyimide resin or polyamide resin in which a resistance adjuster or the like such as carbon black is dispersed. Furthermore, the belt support roller 22 is a drive roller driven by a drive device (not illustrated), the belt support rollers 23, 24, and 27 are driven rollers that hold a running position or the like of the intermediate transfer belt 21, the belt support roller 25 is a backup roller for the second transfer, and the belt support roller 26 is a tension applying roller that applies tension to the intermediate transfer belt 21.

The second transfer device 30 is a contact-type transfer device that includes a second transfer roller that is in contact with a circumferential surface of the intermediate transfer belt 21 so as to be rotated at the second transfer position which is part of the outer circumferential surface of the intermediate transfer belt 21 where the intermediate transfer belt 21 is supported by the belt support roller 25 of the intermediate transfer device 20. A second transfer voltage is supplied to the second transfer roller at the second transfer position. The second transfer voltage is supplied to the second transfer device 30 or the support roller 25 of the intermediate transfer device 20. The second transfer voltage is a direct-current voltage the polarity of which is the same as or opposite to the polarity to which the toner is charged.

The belt cleaner 28 cleans the intermediate transfer belt 21 by removing the adhering matter such as residual toner adhering to the circumferential surface of the intermediate transfer belt 21 after the second transfer has been performed.

The fixing device 40 includes a fixing belt 41 and a pressure roller 42 disposed therein. The endless fixing belt 41 is heated by a heating member 44 according to the present exemplary embodiment so that a surface temperature of the fixing belt 41 is maintained at a required temperature. The pressure roller 42 is in contact with the fixing belt 41 in the substantially axial direction of the fixing belt 41 at a specified pressure and is rotated. The pressure roller 42 serves as an example of a pressure applying member. A contact portion where the fixing belt 41 and the pressure roller 42 are in contact with each other serves as a fixing process portion where required fixing processes (heating and applying pressure) are performed in this fixing device 40. The structure of the fixing device 40 will be described in detail later.

The sheet feed device 50 is disposed below the image forming devices 10 (Y, M, C, and K) for yellow (Y), magenta (M), cyan (C), and black (K). This sheet feed device 50 includes one or more sheet containers 51 and feed devices 52 and 53. The sheet container 51 or the sheet containers 51 contain the stacked recording sheets 5 of, for example, the size or sizes and the type or types a user wishes to use. The feed devices 52 and 53 feed one sheet after another from the recording sheets 5 in the sheet container 51 or each of the sheet containers 51. The sheet container 51 or the sheet containers 51 are attached so as to allow the sheet container 51 or the sheet containers 51 to be drawn toward, for example, a front surface (side surface facing the user who operates the sheet container 51 or the sheet containers 51) side of the body 1a.

The examples of the recording sheets 5 include, for example, plain paper, overhead projector (OHP) films, and the like used for an electrophotographic copier, an electrophotographic printer, and the like. In order to improve smoothness of image surfaces after fixing, smoothness of the sides of the recording sheets 5 is increased as much as possible. For example, coated paper made by coating the surface of plain paper by resin or the like, so-called cardboard such as art paper for printing having a comparative large basis weight, and the like may also be used.

A sheet feed transport path 55 is provided between the sheet feed device 50 and the second transfer device 30. The sheet feed transport path 55 includes one or more sheet transport roller pairs 54, a transport guide (not illustrated), and so forth. The sheet transport roller pair 54 or the sheet transport roller pairs 54 transport the recording sheets 5 fed from the sheet feed device 50 to the second transfer position. The sheet transport roller pair 54 or the sheet transport roller pairs 54 are, for example, rollers that adjust timing at which each of the recording sheets 5 is transported (registration rollers). Furthermore, a sheet output roller pair 57 is disposed near a sheet output opening formed in the image forming apparatus body la. The sheet output roller pair 57 is used for outputting each of the recording sheets 5 having undergone fixing and fed from the fixing device 40 to a sheet output unit 56 provided in an upper portion of the body 1a.

### An Operation of the Image Forming Apparatus

An image forming operation performed by the image forming apparatus 1 is described below.

Here, an operation in which a full-color image is formed by combining the toner images of four colors (Y, M, C, and K) performed by four image forming devices 10 (Y, M, C, and K) is described.

Upon reception of instruction information requesting the image forming operation (printing), the image forming apparatus 1 starts four image forming devices 10 (Y, M, C, and K), the intermediate transfer device 20, the second transfer device 30, the fixing device 40, and so forth.

Consequently, in the image forming devices 10 (Y, M, C, and K), the photosensitive drums 11 are initially rotated in the arrow A direction, and the chargers 12 charge the surfaces of the respective photosensitive drums 11 to the required polarity (negative polarity according to the present exemplary embodiment) and the required potentials. Next, the light exposure devices 13 radiate the light emitted in accordance with image signals obtained by converting image information input to the image forming apparatus 1 into color components (Y, M, C, and K) to the surfaces of the charged photosensitive drums 11. Thus, the electrostatic latent images for the respective color components having the required potentials are formed on the surfaces of the photosensitive drums 11.

Next, the image forming devices 10 (Y, M, C, and K) each supply the toner of a corresponding one of the color components (Y, M, C, and K) charged to the required polarity (negative polarity) from the developing roller to the electrostatic latent image for the corresponding one of the color components formed on the photosensitive drum 11. Thus, the electrostatic latent image is developed by causing the toner to electrostatically adhere to the photosensitive drum 11. Through this development, the electrostatic latent image for the corresponding one of the color components formed on the photosensitive drum 11 is developed with the toner of the corresponding one of four colors (Y, M, C, and K) and becomes a visual toner image of the color.

Next, when the toner images of the colors formed on the photosensitive drums 11 of the image forming devices 10 (Y, M, C, and K) are transported to the first transfer positions, the first transfer devices 15 cause the toner images of the colors to be transferred through the first transfer onto the intermediate transfer belt 21 of the intermediate transfer device 20 rotated in the arrow B direction such that the toner images are sequentially superposed on one another.

The drum cleaners 16 clean the surfaces of the photosensitive drums 11 by removing the adhering matter such that the adhering matter is scraped off from the surfaces of the photosensitive drums 11 in the image forming devices 10 where the first transfer has been performed. Thus, the image forming devices 10 are ready to perform the next image forming operation.

Next, the toner images having been transferred onto the intermediate transfer belt 21 through the first transfer are held and transported to the second transfer position by rotating the intermediate transfer belt 21 in the intermediate transfer device 20. Meanwhile, the sheet feed device 50 feeds the required recording sheet 5 to the sheet feed transport path 55 in accordance with the image forming operation. The recording sheet 5 is fed to the second transfer position by the sheet transport roller pair 54 or the sheet transport roller pairs 54 serving as the registration rollers at timing adjusted to timing of the transfer in the sheet feed transport path 55.

The second transfer roller of the second transfer device 30 causes the toner images on the intermediate transfer belt 21 to be collectively transferred onto the recording sheet 5 through the second transfer at the second transfer position. Furthermore, the belt cleaner 28 cleans the surface of the intermediate transfer belt 21 by removing the adhering matter such as the toner remaining on the surface of the intermediate transfer belt 21 after the second transfer has been performed in the intermediate transfer device 20 having undergone the second transfer.

Next, the recording sheet 5 onto which the toner images have been transferred through the second transfer is removed from the intermediate transfer belt 21 and the second transfer device 30 and then transported to the fixing device 40. The recording sheet 5 having undergone the second transfer is introduced into and passes through the contact portion between the rotating fixing belt 41 and the pressure roller 42 so as to be subjected to a required fixing processes (heating and application of pressure) in the fixing device 40. Thus, the unfixed toner images are fixed onto the recording sheet 5. At last, in the case of the image forming operation where image formation is performed on only one of the faces of the recording sheet 5, the recording sheet 5 having undergone the fixing is output to, for example, the sheet output unit 56 provided in the upper portion of the body 1a by the sheet output roller pair 57.

Through the above-described operation, the recording sheet 5 on which the full-color image made by combining the toner images of four colors is formed is output.

### The Structure of the Fixing Device

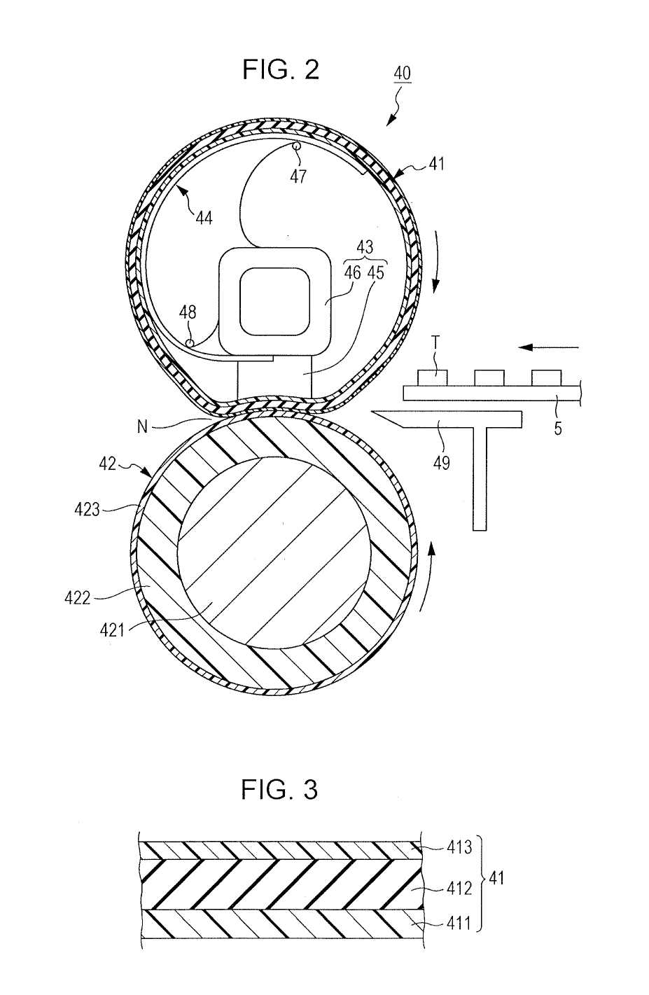

FIG. 2 is a sectional view of the structure of the fixing device according to the first exemplary embodiment.

As illustrated in FIG. 2, the fixing device 40 includes the fixing belt 41, the pressure roller 42, a pressing member 43, and the heating member 44. The endless fixing belt 41 heats unfixed toner images T on the recording sheet 5 so as to fix the toner images T. The pressure roller 42 serves as the example of the pressure applying member that presses the recording sheet 5 against the fixing belt 41. The pressing member 43 presses the fixing belt 41 from an inner circumference against the pressure roller 42. The heating member 44 according to the present exemplary embodiment is disposed such that the heating member 44 is in (tight) contact with the inner circumferential surface of the fixing belt 41 so as to heat the fixing belt 41. The contact portion where the fixing belt 41 and the pressure roller 42 are in (pressure) contact with each other serves as a fixing process portion (nip) N where the fixing processes in which the recording sheet 5 is heated and subjected to pressure are performed in this fixing device 40.

The fixing belt 41 is formed of a thin sheet-shaped flexible member. The fixing belt 41 has a thin-walled cylindrical shape having an outer diameter of about 20 to 50 mm in sectional view before the fixing belt 41 is brought into pressure contact with the pressure roller 42 and deformed. According to the present exemplary embodiment, the outer diameter of the fixing belt 41 is set to 30 mm. Furthermore, the length of the fixing belt 41 in the axial direction (longitudinal direction) is greater than a maximum width of the recording sheet 5. This length of the fixing belt 41 is, for example, 320 mm.

As illustrated in FIG. 3, the fixing belt 41 includes, for example, a base layer 411, an elastic body layer 412, and a mold release surface layer 413. The elastic body layer 412 and the mold release surface layer 413 are sequentially stacked on an outer circumferential surface of the base layer 411 in this order. The number of layers of the fixing belt 41 may be less than the above-described number, or the fixing belt 41 may include a different layer or different layers according to need. The fixing belt 41 may have any layer structure. The fixing belt 41 is rotated by following the rotation of the pressure roller 42.

The base layer 411 is formed of, for example, polyimide resin, which is highly heat-resistant synthetic resin, or a metal material such as iron, nickel, copper, zirconium, or cobalt, or an alloy of any of these metal materials. The thickness of the base layer 411 is set to about 10 to 200 μm. According to the present exemplary embodiment, the base layer 411 is formed of polyimide resin having a thickness of 80 μm.

The elastic body layer 412 is formed of a heat-resistant elastic body such as silicone rubber or fluorocarbon rubber. The toner images T held by the recording sheet 5 as the recording medium are formed by stacking toner of the plural colors, the toner of the plural colors being configured of powder.

In particular, when the toner images T are of a full-color image, the total amount of the toner is large. Thus, in order to uniformly heat and fuse the toner images T in the nip N of the fixing device 40, the surface of the fixing belt 41 is elastically deformed by following the irregularities of the toner images T on the recording sheet 5. According to the present exemplary embodiment, the elastic body layer 412 is formed of silicone rubber, the thickness of which is 100 to 600 μm, for example, 200 μm, and hardness according to Japanese Industrial Standard (JIS) A of which is 10 to 30°.

The mold release surface layer 413 stacked on the surface of the elastic body layer 412 is in direct contact with the unfixed toner images T held on the recording sheet 5, and accordingly, formed of a material having a high mold release property. The mold release surface layer 413 is formed of, for example, tetrafluoroetylene-perfluoroalkylvinylether copolymer (PFA), polytetrafluoroethylene (PTFE), silicone copolymer, or a multilayer of these materials. When the mold release surface layer 413 is excessively thin, wear resistance may be insufficient, and accordingly, the life of the fixing belt 41 may be reduced. In contrast, when the mold release surface layer 413 is excessively thick, heat capacity of the fixing belt 41 may become excessively large, and accordingly, warm-up time is increased. Thus, according to the present exemplary embodiment, by considering a balance between the wear resistance and the heat capacity, the thickness of the mold release surface layer 413 is set to a value from 10 to 50 μm, for example, 30 μm.

As illustrated in FIG. 2, the pressure roller 42 includes a cored bar member 421, an elastic body layer 422, and a mold release layer 423. The cored bar member 421 having a columnar shape is formed of metal such as stainless steel, aluminum, or steel. The heat-resistant elastic body layer 422 is formed of, for example, silicone rubber having a predetermined thickness (for example, about 5 mm) coated on a surface of the cored bar member 421. The mold release layer 423 having a thickness of, for example, about 50 μm is formed of a material having a good mold release property such as a PFA tube and coated on a surface of the elastic body layer 422. The pressure roller 42 has a solid columnar shape having an outer diameter of, for example, about 28 mm.

A so-called SOLT roller (brand name) is used as the pressure roller 42. The SOLT roller is structured as follows: that is, plural small-diameter through holes (not illustrated) penetrate through the inside of the elastic body layer 422, which is formed of a silicone sponge layer having a comparatively low elastic modulus, in the axial direction. The small-diameter holes are equally spaced apart from one another in a circumferential direction. The mold release layer 423 formed of the PFA tube is coated on an outer circumference of the elastic body layer 422. Since the pressure roller 42 using the SOLT roller includes the elastic body layer 422 of the silicone sponge layer having a comparatively low elastic modulus on the surface side, a comparatively large nip N (nip width) may be obtained even when the outer diameter of the roller is comparatively small. Thus, the diameter of the pressure roller 42 may be reduced.

Furthermore, since the elastic body layer 422 of the pressure roller 42 has the plural through holes (not illustrated), the pressure roller 42 has comparatively low heat capacity and a good thermal insulation property. Thus, thermal transfer from the fixing belt 41 may be suppressed. At the start of heating, the pressure roller 42 quickly follows an increase in the temperature of the fixing belt 41. This may reduce the warm-up time. Despite this, the pressure roller 42 is not limited to the SOLT roller (brand name). Of course, the pressure roller 42 may be a solid roller without a through hole. The pressure roller 42 is rotated at a predetermined rotational speed by a drive unit (not illustrated). The rotational speed of the pressure roller 42 is set to a circumferential speed (for example, 252 mm/s) equal to the process speed of the image forming section 6.

The pressing member 43 includes a pressing pad 45 and a support member 46. The pressing pad 45 is pressed against the inner circumferential surface of the fixing belt 41. The support member 46 supports the pressing pad 45. The pressing pad 45 is fixed to the support member 46 by adhesion or a mechanical fixing part such as a screw and attached. In so doing, as illustrated in FIG. 5, a metal sheet 45a may be used. In this case, the metal sheet 45a is fastened onto a rear surface side of the pressing pad 45 by, for example, adhesion. FIG. 5 illustrates a sectional shape of the pressing pad 45 before the pressing pad 45 is pressed by the pressure roller 42 with the fixing belt 41 interposed therebetween. Furthermore, the pressing pad 45 may be provided such that both side surfaces of the pressing pad 45 in a rotational direction of the fixing belt 41 are held between a pair of plate members (not illustrated) provided in the support member 46 or the pressing pad 45 is fitted into a recess (not illustrated) provided in the support member 46. The length of the pressing pad 45 is substantially equal to that of the fixing belt 41. This pressing pad 45 is in pressure contact with the pressure roller 42 with the fixing belt 41 interposed therebetween, thereby forming the nip N between the fixing belt 41 and the pressure roller 42. The pressing pad 45 is in pressure contact with the pressure roller 42 substantially over its entire length.

The pressing pad 45 is formed of an elastic body such as, for example, silicone rubber or fluorocarbon rubber. However, the material that forms the pressing pad 45 is not limited to this. The pressing pad 45 may be formed of a synthetic resin material having heat resistance and low thermal conductivity. Examples of such a material include polyimide resin, polyamide resin, phenol resin, polyethersulfone (PES) resin, polyphenylenesulfide (PPS) resin, a liquid crystal polymer (LCP) and other heat-resistant resin. According to the present exemplary embodiment, the pressing pad 45 is formed of a heat-resistant elastic body such as silicone rubber or fluorocarbon rubber.

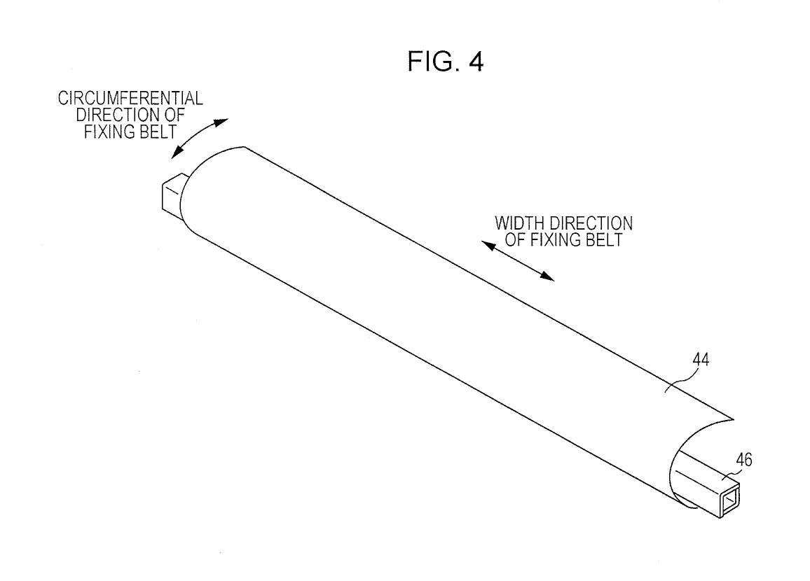

As illustrated in FIG. 2, the support member 46 is formed to have a solid or hollow elongated box shape having a rectangular section so as to have stiffness with which the amount of bending is a predetermined value or less when the support member 46 receives a pressure contact force from the pressure roller 42 through the pressing pad 45. The support member 46 is formed of, for example, metal such as stainless steel, aluminum, or iron or heat-resistant resin such as glass fiber-mixed PPS. The pressure contact force by which the support member 46 is in pressure contact with the pressure roller 42 with the pressing pad 45 therebetween is set to, for example, 30 kgf. Reference numeral 49 of FIG. 2 indicates a sheet guide that guides the recording sheet 5 to the nip N. As illustrated in FIG. 4, the flexible surface heating member 44 is formed of a flexible thin sheet-shaped member having a rectangular shape in plan view. The flexible surface heating member 44 is, as illustrated in FIG. 5, positioned along a portion of the fixing belt 41 in a circumferential direction of the fixing belt 41 (end portion on an upstream side in the rotational direction of the fixing belt 41). A proximal end portion 44a on the long side having a comparatively large length is fixed to the support member 46. According to the exemplary embodiment illustrated in, for example, FIG. 5, the proximal end portion 44a of the heating member 44 is held between the support member 46 and the pressing pad 45 so as to be fixed. Alternatively, the proximal end portion 44a of the heating member 44 may be fixed by a pair of plate members (not illustrated) provided in the support member 46 by using screwing or another method. A region of the flexible surface heating member 44 on the opposite end portion side, that is, a large region (contact region) 44c on a free end portion 44b side where the heating member 44 is not fixed is disposed so as to be in contact with the inner circumferential surface of the fixing belt 41 by a contact force of about 3 kgf applied due to an repulsive elastic force of the flexible surface heating member 44 itself. The heating member 44 also has a region 44d that is separated from the support member 46, positioned on the proximal end portion 44a side, and determined by the curvature of the heating member 44. The region 44d defines a non-contact region not in contact with the inner circumferential surface of the fixing belt 41.

As illustrated in FIG. 5, the heating member 44 is curved in advance to have a substantially arc shape having a larger radius of curvature than that of the fixing belt 41 before the heating member 44 is attached inside the fixing belt 41. The heating member 44 is inserted from one of opening end portions in the axial direction of the fixing belt 41 into the fixing belt 41 while the heating member 44 is bent. The diameter of the heating member 44 is enlarged by an elastic recovery force of the heating member 44 itself, and the heating member 44 is attached so that the heating member 44 is in uniform contact (uniform tight contact) with the inner circumferential surface of the fixing belt 41. The length of the heating member 44 in the circumferential direction is appropriately set. In an example illustrated in FIG. 5, the distal end of the free end portion 44b of the heating member 44 is positioned at about a two o′clock position in the clockwise direction of the fixing belt 41. Although the ability of the heating member 44 to heat the fixing belt 41 may increase as the area of the contact region 44c of the heating member 44 is increased, the sliding resistance with the fixing belt 41 also increases. Accordingly, the contact region 44c of the heating member 44 is appropriately set by considering the heating ability and the sliding resistance.

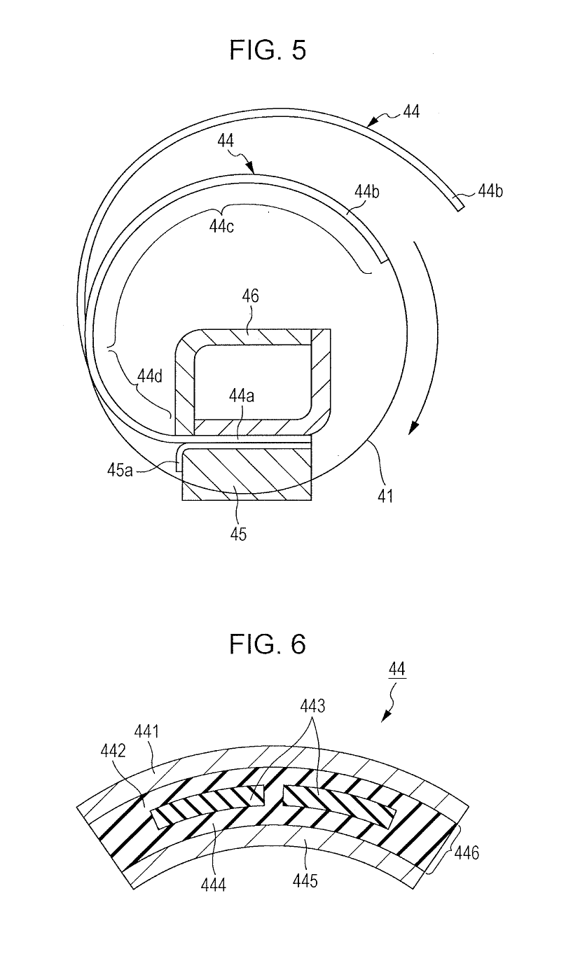

As illustrated in FIG. 6, the heating member 44 is a thin-film flexible heater having a five-layer structure that includes the following layers: that is, when seen from a side in contact with the inner circumferential surface of the fixing belt 41 (upper side in FIG. 6), a metal layer 441, an insulation layer 442, a metal layer (heating layer) 443, an insulation layer 444, and a metal layer 445. The heating member 44 includes a flexible surface heater 446 that is formed of the insulation layers 442 and 444 positioned on front and rear surface sides with the heating layer including the metal layer 443 sandwiched therebetween. The metal layer 441 disposed on an outer circumference side of the flexible surface heater 446 functions as a thermal transfer layer that transfers heat from the flexible surface heater 446 to the inner circumferential surface of the fixing belt 41. The metal layer 445 disposed on an inner circumferential surface side of the flexible surface heater 446 and the metal layer 441 disposed on the outer circumferential side function as support layers that support the flexible surface heater 446.

The metal layer 441, the insulation layer 442, the metal layer 443, the insulation layer 444, and the metal layer 445 included in the heating member 44 are included in metal layers and insulation layers that are stacked one on top of another and have different thermal expansion coefficients. Thus, in order to prevent separation of the metal layers and the insulation layers from one another, the metal layer 441, the insulation layer 442, the metal layer 443, the insulation layer 444, and the metal layer 445 are bonded to one another by adhesive layers (not illustrated). Furthermore, since the flexible surface heater 446 is sandwiched between the metal layers 441 and 445 disposed on the outer and inner circumference sides in the heating member 44, separation of the metal layers and the insulation layers from one another may be effectively prevented. Thus, when the flexible surface heater 446 is initially fabricated, and then the metal layers 441 and 445 are provided on the front and rear surfaces of the flexible surface heater 446 in the fabrication of the heating member 44, adherence of the metal layers and the insulation layers may be increased by setting the radius of curvature of the metal layer 441 disposed on the outer circumference side to be smaller than that of the metal layer 445 disposed on the inner circumference side.

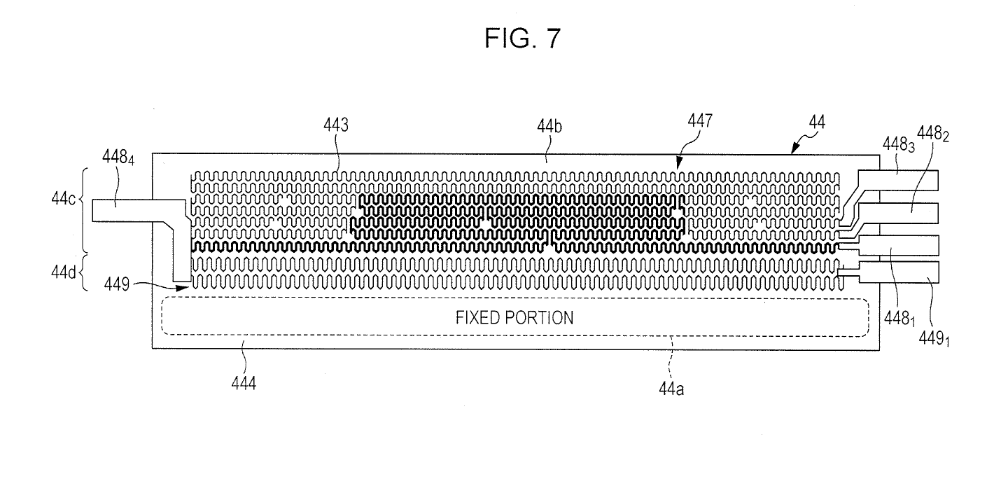

The above-described five-layer structure of the heating member 44 is, for example, as illustrated in FIG. 7, formed as follows: the 30 μm thick heating layer (metal layer) 443 is formed of stainless steel in a predetermined pattern on a surface of the 25 μm thick insulation layer 444 formed of polyimide resin; a surface of the stainless-steel heating layer 443 is coated with the 25 μm thick insulation layer 442 formed of polyimide resin; and surfaces of the insulation layers 442 and 444 positioned on the front and rear sides are coated with the 30 μm thick thermal transfer layer (metal layer) 441 and the support layer (metal layer) 445 formed of stainless steel. The metal layer 443 having the predetermined pattern as described above forms a heating portion 447. The width, the length, and the thickness of this flexible surface heating member 44 are respectively set to, for example, 320 mm, 75 mm, and 0.14 mm. Furthermore, in the flexible surface heating member 44, the length of the contact region 44c in contact with the inner circumferential surface of the fixing belt 41 (the length when expanded in a plane) is set to 45 mm, and the length of the region 44d not in contact with the inner circumferential surface of the fixing belt 41 is set to 15 mm, and the length of the fixed portion 44a fixed to the support member 46 is set to 15 mm.

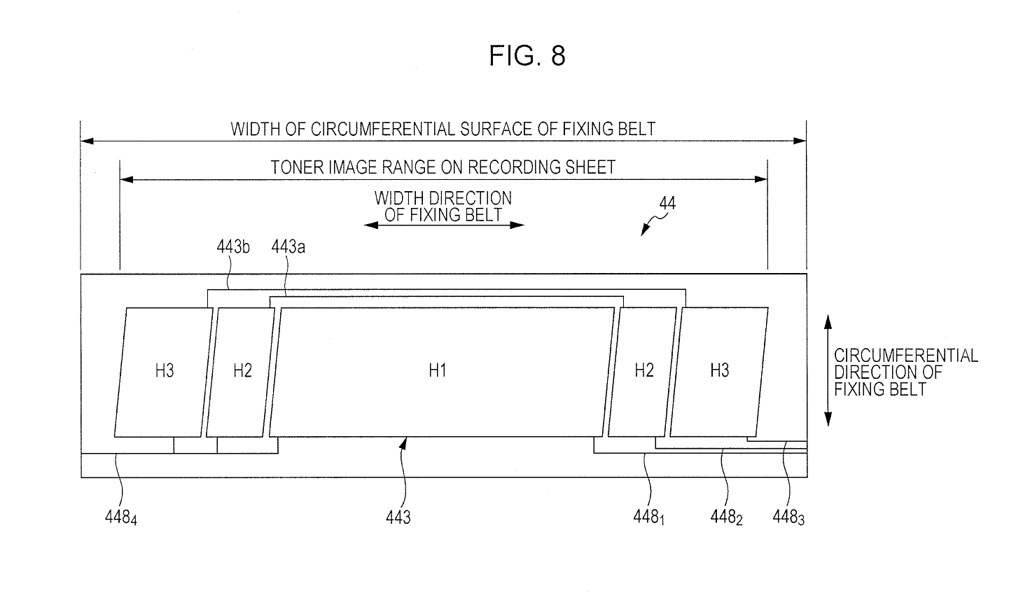

The heating portion 447 that includes the heating layer 443 formed of stainless steel is, as schematically illustrated in FIG. 8, divided into three types of heating regions H1, H2, and H3. In more detail, the heating portion 447 has the first heating region H1 corresponding to a type of the recording sheets 5 having a smallest size, the second heating regions H2 corresponding to a type of the recording sheets 5 having an intermediate size, and the third heating regions H3 corresponding to a type of the recording sheets 5 having a largest size. Portions of the curved heating layer 443 formed of stainless steel are uniformly distributed over the first to third heating regions H1, H2, and H3 of the heating portion 447. The first heating region H1 has a rectangular shape having a required width and a required length in a central portion in a width direction of the flexible surface heating member 44. The second heating regions H2 are adjacent to both end sides of the first heating region H1 in the width direction and each have a rectangular shape having a required width and a required length. Furthermore, the third heating regions H3 are adjacent to both end sides of the second heating regions H2 in the width direction and each have a rectangular shape having a required width and a required length. The left and right second heating regions H2 are connected to each other through a second heating layer for conduction 443a, and the left and right third heating regions H3 are connected to each other through a third heating layer for conduction 443b. The second and third heating layers for conduction 443a and 443b are provided on an upper portion (top portion) of the first heating region H1.

The heating layer 443 that forms the first to third heating regions H1, H2, and H3 includes first to third electrodes 448₁, 448₂, and 448₃ at its right end portion so as to selectively supply power to the heating regions. Furthermore, the heating layer 443 that forms the first to third heating regions H1, H2, and H3 includes a common electrode 448₄ on its left end portion so as to collectively supply the power to the first to third heating regions H1, H2, and H3.

Also according to the present exemplary embodiment, as illustrated in FIG. 7, an auxiliary heating portion 449 that supplementally heats the non-contact region disposed on the fixed end 44a side of the heating member 44 is provided so as to suppress the difference in temperature caused between the free end 44b side and the fixed end 44a side of the heating member 44 (flexible surface heater).

The auxiliary heating portion 449 is provided between a proximal end portion of the heating portion 447 of the heating member 44 and the fixed portion 44a of the heating member 44 so as to be adjacent to the proximal end portion side of the heating portion 447. As is the case with the heating portion 447, portions of the curved heating layer 443 formed of stainless steel are uniformly distributed over the auxiliary heating portion 449. Furthermore, the auxiliary heating portion 449 has a rectangular shape in plan view extending over the entire length of the heating member 44 having a required length. The auxiliary heating portion 449 includes electric power electrode 449₁ for power supply at its right end portion. A left end portion of the auxiliary heating portion 449 is connected to the common electrode 448₄.

Power consumptions of the heating portion 447 and the auxiliary heating portion 449 of the heating member 44 according to the present exemplary embodiment are respectively set to, for example, 900 W (100V) and 75 W (100 V).

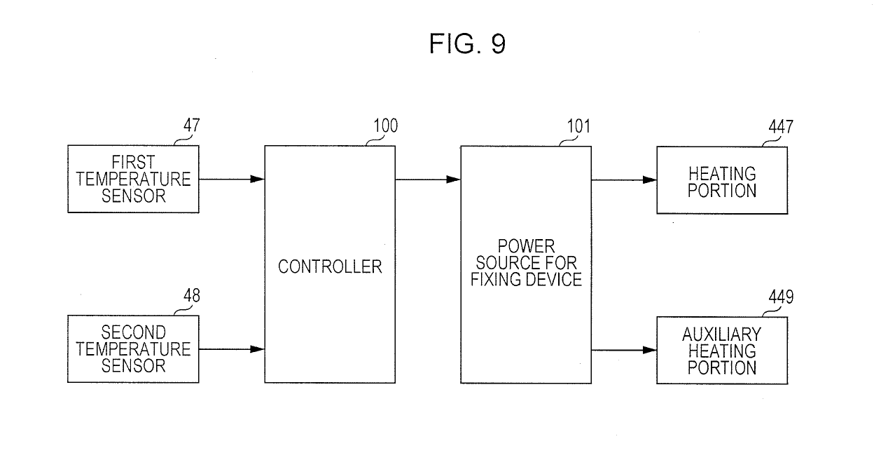

Furthermore, as illustrated in FIG. 9, the fixing device 40 includes a controller 100 that serves as an example of a controller and controls electric power of the heating portion 447 and the auxiliary heating portion 449 of the heating member 44. As illustrated in FIG. 2, the fixing device 40 also includes a first temperature sensor 47 and a second temperature sensor 48. The first temperature sensor 47 serves as an example of a temperature detector and detects the temperature of the heating portion 447 of the heating member 44. The second temperature sensor 48 serves as an example of a temperature detector and detects the temperature of the auxiliary heating portion 449. Detection signals from the first and second temperature sensors 47 and 48 are input to the controller 100. The controller 100 controls electric power of the heating portion 447 and the auxiliary heating portion 449 of the heating member 44 through a power source for the fixing device 101 in accordance with the detection signals from the first and second temperature sensors 47 and 48 so that the temperatures of the heating portion 447 and the auxiliary heating portion 449 of the heating member 44 are equal to preset temperatures.

### Operations of a Characteristic Component (Fixing Device) of the Image Forming Apparatus

Upon reception of the instruction information requesting the image forming operation (printing), the controller 100 causes the fixing device 40 to start at predetermined timing.

Upon reception of the instruction information requesting the image forming operation, the heating member 44 for the fixing belt 41 of the fixing device 40 is supplied with the power so as to heat the fixing belt 41 so that the surface temperature of the fixing belt 41 becomes a required temperature. When the surface temperature of the fixing belt 41 reaches the required temperature, the pressure roller 42 is started to be rotated. The fixing belt 41 is rotated by following the rotation of the pressure roller 42.

As illustrated in FIG. 2, when the toner images T formed on the recording sheet 5 by the image forming section 6 of the image forming apparatus 1 reach the nip N of the fixing device 40, the unfixed toner images T on the recording sheet 5 are fixed onto the recording sheet 5 due reception of heat from the fixing belt 41 and a pressure force from the pressure roller 42 while passing through the nip N.

In so doing, when the recording sheet 5 is introduced into the nip N of the fixing device 40, the toner images T formed on a front side of the recording sheet 5 are heated by the fixing belt 41 and fused, and subjected to the pressure force applied by the fixing belt 41 pressed from inside by the pressing pad 45 and the pressure roller 42. Thus, the heated and fused toner images T are fixed onto the recording sheet 5.

A region of the fixing belt 41 corresponding to the contact region 44c, where the heating member 44 is in contact with the fixing belt 41, is heated from the inner circumferential surface side by the flexible surface heating member 44 in tight contact with the inner circumferential surface of the fixing belt 41.

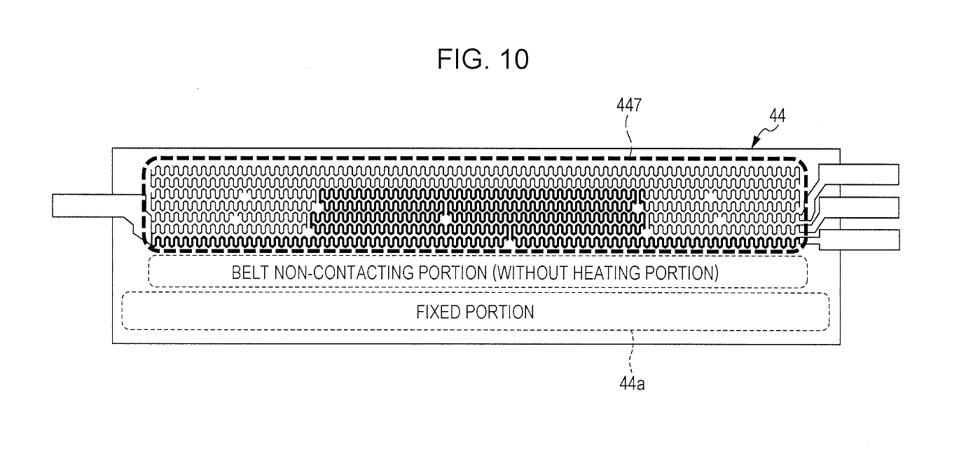

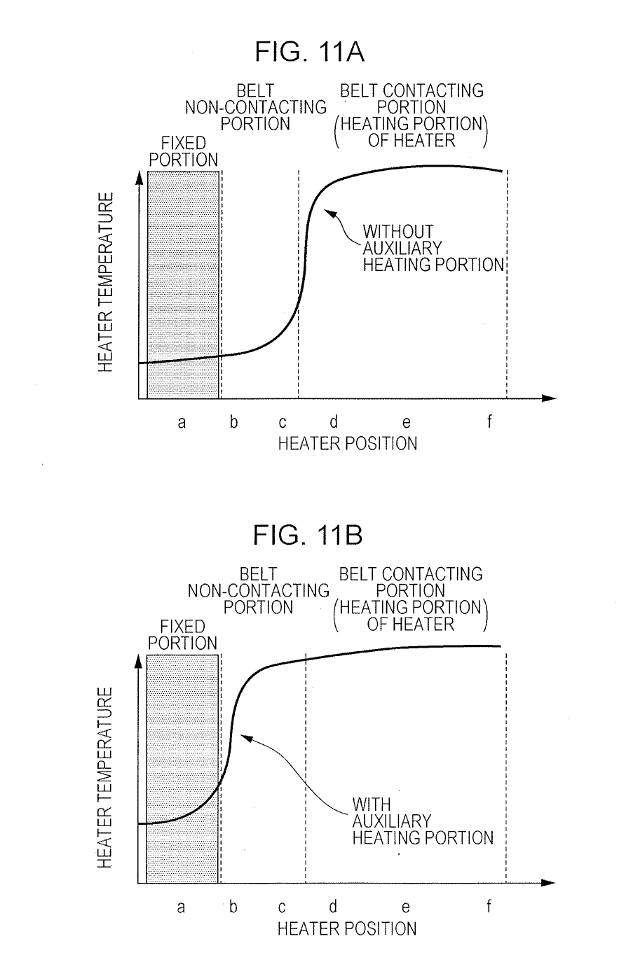

As illustrated in FIG. 7, the flexible surface heating member 44 is heated when the heating portion 447 is heated, and the temperature of a region corresponding to the heating portion 447 positioned on the distal end side (free end side) 44b of the heating member 44 increases. At this time, in the case where the heating member 44 includes only the heating portion 447 and does not include the auxiliary heating portion 449 as illustrated in FIG. 10, the temperature increases only at the contact region 44c positioned on the distal end portion 44b side of the heating member 44 and the temperature remains low in the non-contact region 44d positioned on the proximal end portion 44a side (fixed end side) of the heating member 44 as illustrated in FIG. 11A.

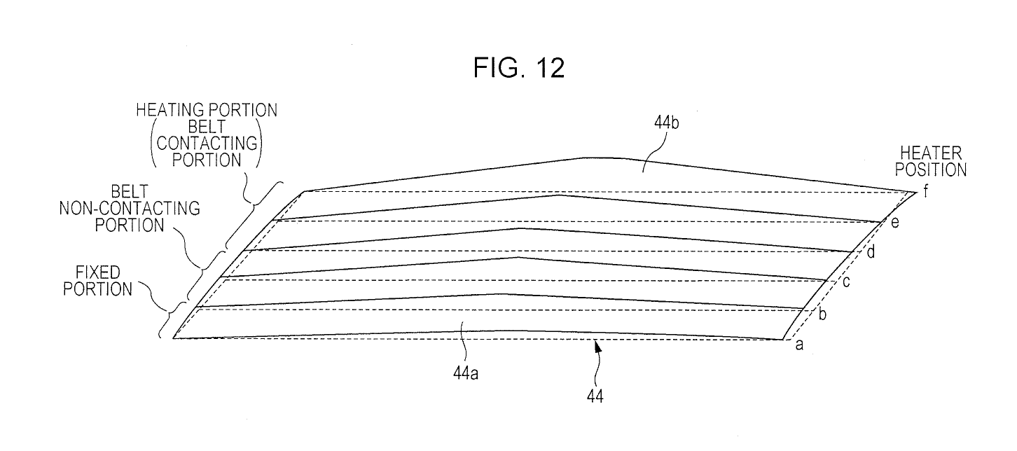

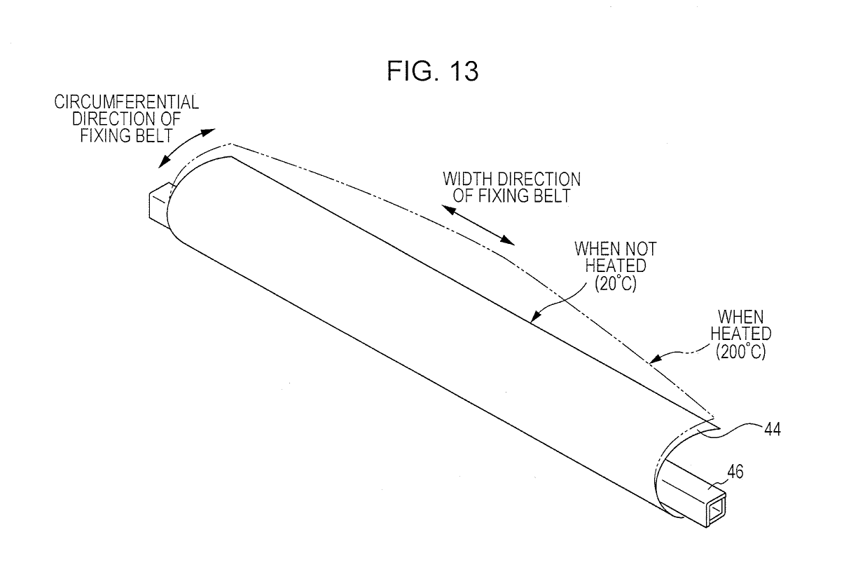

As a result, as illustrated in FIG. 12, thermal expansion occurs in the contact region 44c on the distal end portion 44b side due to the increase in temperature in the flexible surface heating member 44 having a rectangular shape in plan view. In contrast, the temperature is low and little thermal expansion occurs in the non-contact region 44d of the heating member 44 on the proximal end portion 44a side compared to the distal end portion side. Thus, little thermal expansion (thermal deformation) occurs in regions denoted by signs a and b corresponding to the fixed portion 44a fixed by the support member 46 of the heating member 44. In contrast, the degree of thermal expansion (thermal deformation) is large in the contact region 44c denoted by signs d to f corresponding to the heating portion 447 positioned in the distal end portion 44b of the heating member 44. The flexible surface heating member 44 curved into a cylindrical shape is originally intended to be uniformly in tight contact with the inner circumferential surface of the fixing belt 41 in the axial and circumferential directions of the fixing belt 41 as illustrated by solid lines in FIG. 13. However, due to the thermal expansion as described above, the heating member 44 is deformed so that the diameter of the heating member 44 becomes larger in a central portion than in both the end portions in the longitudinal direction of the fixing belt 41, that is, the heating member 44 is deformed into a so-called rhombus-like shape.

The flexible surface heating member 44 deformed into the rhombus-like shape as described above is unlikely to be uniformly in tight contact with the inner circumferential surface of the fixing belt 41, and both the ends of the heating member 44 in the longitudinal direction of the fixing belt 41 are separated from, or, if not separated, only slightly in contact with the inner circumferential surface of the fixing belt 41.

In contrast, as illustrated in FIG. 7, the flexible surface heating member 44 according to the first exemplary embodiment includes the auxiliary heating portion 449 on the proximal end portion 44a side of the heating member 44 adjacent to the heating portion 447. Thus, as illustrated in FIG. 11B, not only the regions positioned on the distal end portion 44b side but also the regions positioned on the proximal end portion 44a side (fixed end side) of the heating member 44 are heated to the temperature that is substantially equal to the temperature of the heating portion 447 due to the auxiliary heating portion 449. The region positioned on the proximal end portion 44a side (fixed end side) of the heating member 44 where the auxiliary heating portion 449 is provided defines the non-contact portion 44d not in contact with the inner circumferential surface of the fixing belt 41. Thus, a decrease in temperature due to thermal transfer to the fixing belt 41 does not occur in the regions on the proximal end portion 44a side.

Thus, as illustrated in FIG. 11B, the heating member 44 may heat the regions positioned on the proximal end portion 44a side (fixed end side) so that the temperature of the regions positioned on the proximal end portion 44a side becomes substantially equal to the temperature of the regions positioned on the distal end portion 44b side heated by the heating portion 447, and accordingly, thermal expansion substantially uniformly occurs in the entire flexible surface heating member 44 having a rectangular shape in plan view. Thus, the heating member 44 is curved into an originally intended cylindrical shape and substantially uniformly in tight contact with the inner circumferential surface of the fixing belt 41 in the axial and circumferential directions of the fixing belt 41. This may prevent or suppress the occurrence of a situation in which the fixing belt 41 is partially separated from the inner circumferential surface of the fixing belt 41, for example, both the end portions of the heating member 44 in the longitudinal direction of the fixing belt 41 are separated from the inner circumferential surface of the fixing belt 41.

### Experimental Example

Next, in order to confirm the effect of the fixing device according to the above-described first exemplary embodiment, a prototype of the fixing device 40 as illustrated in FIG. 2 is fabricated, the flexible surface heating member 44 is heated up to 200° C., and an experiment is performed to measure the displacement of the flexible surface heating member 44 from the inner circumferential surface of the fixing belt 41. The displacement of the flexible surface heating member 44 is measured from the inner circumferential surface side of the fixing belt 41 by a laser positioning instrument.

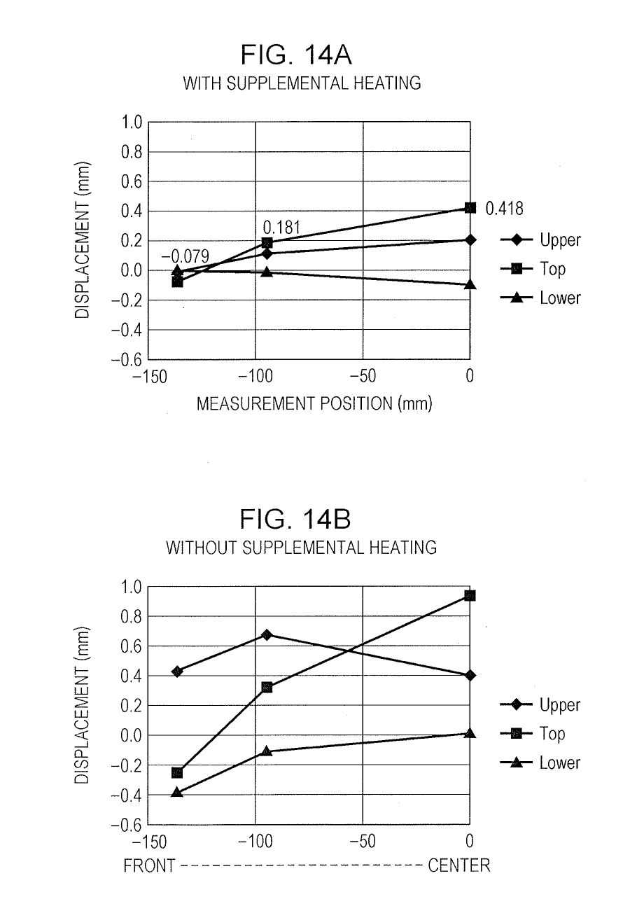

FIG. 14A is a graph illustrating the results of the above-described experimental example. The graph of FIG. 14A illustrates measurements of the displacement of the flexible surface heating member 44 positioned from a central portion to one end portion side in the axial direction of the fixing belt 41. In FIG. 14A, “Lower” means measurements at a position on the proximal end portion 44a side of the heating member 44 in the circumferential direction of the fixing belt 41, “Top” means measurements at a position in the central portion of the heating member 44 in the circumferential direction of the fixing belt 41, and “Upper” means measurements at a position on the distal end portion 44b side of the heating member 44 in the circumferential direction.

As FIG. 14A clearly illustrates, by using the heating member 44 according to the present exemplary embodiment, it is understood that even a maximum displacement of the heating member 44 is successfully suppressed to about −0.1 to 0.418 mm (Δ0.52 mm), which satisfies a target value of 0.60 mm a less.

### Comparative Example

Furthermore, a prototype fixing device 40 using the heating member 44 without the auxiliary heating portion 449 as illustrated in FIG. 10 is fabricated as a comparative example, and measurement is performed similarly to that performed in the experimental example.

FIG. 14B is a graph illustrating the results of the above-described comparative example.

As FIG. 14B clearly illustrates, by using the heating member 44 without the auxiliary heating portion 449, it is found that a maximum displacement of the heating member 44 is very large ×0.4 to 1.0 mm (Δ1.4 mm) that largely exceeds the target value 0.60 mm, and this may lead to poor contact between the heating member 44 and the fixing belt 41.

### Second Exemplary Embodiment

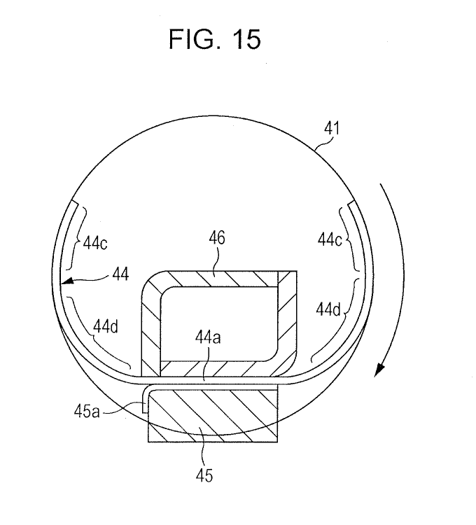

FIG. 15 illustrates the structure of the fixing device according to a second exemplary embodiment of the present invention.

As illustrated in FIG. 15, a central portion 44a of the flexible surface heating member 44 defines a fixed portion fixed to the support member 46 in the fixing device 40 according to the second exemplary embodiment, and the flexible surface heating member 44 has free ends 44b on both the upstream and downstream sides in the rotational direction of the fixing belt 41. The flexible surface heating member 44 has regions 44c positioned on the upstream and downstream free end 44b sides in contact with the inner circumferential surface of the fixing belt 41 and non-contact regions 44d between the fixed portion 44a and the contact regions 44c.

As described above, the one of the end portions of the flexible surface heating member 44 is not necessarily fixed. A portion of the heating member 44 such as a central portion may be fixed. Furthermore, the fixed portion 44a of the heating member 44 is not necessarily disposed in the central portion. The fixed portion 44a may be provided at a position near one of the upstream and downstream sides in the rotational direction of the fixing belt 41.

Although the full-color image forming apparatus has been described in the exemplary embodiments, the technology described herein is similarly applicable to a monochrome image forming apparatus.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. A heating member comprising:
a flexible surface heater comprising:
a fixed end side;
a free end side;
a contact region in contact with a member to be heated on the free end side;
a non-contact region on the fixed end side; and
a heating portion in the contact region; and
an auxiliary heating portion that supplementally heats the non-contact region on the fixed end side of the flexible surface heater so as to suppress an occurrence of a temperature difference between the free end side and the fixed end side of the flexible surface heater.

2. The heating member according to claim 1,
wherein the flexible surface heater comprises:
a front surface;
a rear surface;
a heating layer formed to have a predetermined shape; and
a pair of insulation layers disposed on the front surface and the rear surface, and
wherein the heating layer is formed between the pair of insulation layers.

3. The heating member according to claim 1,
wherein the flexible surface heater has a curved shape having a greater radius of curvature than that of the member to be heated having a cylindrical shape.

4. A fixing device comprising:
an endless fixing belt comprising an inner circumferential surface and a space defined on an inner circumferential surface side thereof;
a pressure applying member configured to press a recording medium that holds a toner image against the fixing belt;
a pressing member that is disposed in the space and that is configured to press the fixing belt toward the pressure applying member; and
the heating member according to claim 1 that is in contact with the inner circumferential surface of the fixing belt so as to heat the fixing belt.

5. The fixing device according to claim 4, further comprising:
a controller configured to control electric power of the heating portion and the auxiliary heating portion of the heating member.

6. An image forming apparatus comprising:
an image forming unit configured to form an image on a recording medium; and
the fixing device according to claim 4 configured to fix the image formed on the recording medium using the image forming unit.

7. The heating member according to claim 1, wherein the free end side is a side of the flexible surface heater where the flexible surface heater is unfixed.

8. The heating member according to claim 1, wherein the member to be heated comprises a fixing belt, and
wherein the non-contact region is not in contact with the fixing belt.

9. The heating member according to claim 1, wherein the heating portion extends across substantially an entire length of the flexible surface heater in an axial direction.

10. The heating member according to claim 9, wherein the auxiliary heating portion extends across substantially an entire length of the flexible surface heater in the axial direction.

11. The heating member according to claim 1, wherein the heating portion and the auxiliary heating portion are configured to provide heat such that thermal expansion occurs substantially uniformly throughout an entire surface of the flexible surface heater.

12. The heating member according to claim 1, wherein the heating portion and the auxiliary heating portion are configured to provide heat such that a maximum displacement of the heating member from a central portion to an end portion side in an axial direction is suppressed to less than Δ0.60 mm.

13. The heating member according to claim 12, wherein the heating portion and the auxiliary heating portion are configured to provide heat such that the maximum displacement of the heating member from the central portion to the end portion side in an axial direction is suppressed to Δ0.52 mm or less.

14. The heating member according to claim 8, wherein the auxiliary heating portion is configured such that the auxiliary heating portion does not significantly heat the fixing belt.
